(19) United States
(12) Patent Application Publication
(10) Pub. No.: US 2023/0407181 A1
(43) Pub. Date: Dec. 21, 2023

(54) Liquid Crystalline Polymer Composition having a Low Dielectric Constant

(71) Applicant: Ticona LLC, Florence, KY (US)

(72) Inventors: Xiaowei Zhang, Union, KY (US); Xinyu Zhao, Cincinnati, OH (US)

(21) Appl. No.: 18/335,169

(22) Filed: Jun. 15, 2023

Related U.S. Application Data
(60) Provisional application No. 63/353,973, filed on Jun. 21, 2022.

(51) Int. Cl. C09K 19/54; C08G 77/00

(52) U.S. Cl. CPC C09K 19/544; C08G 77/80; C09K 2219/13; C09K 2019/521

(57) ABSTRACT

A polymer composition that includes a polyhedral silsesquioxane (POSS) dispersed within a polymer matrix that contains a thermotropic liquid crystalline polymer is provided. The polyhedral silsesquioxane contains an aromatic group. The polymer composition exhibits a dielectric constant of about 4.5 or less as determined at a frequency of 10 GHz.

### RELATED APPLICATION

The present application is based upon and claims priority to U.S. Provisional Patent Application Ser. No. 63/353,973, having a filing date of Jun. 21, 2022, which is incorporated herein by reference.

### BACKGROUND OF THE INVENTION

Electrical components often contain molded parts that are formed from a liquid crystalline, thermoplastic resin. Recent demands on the electronic industry have dictated a decreased size of such components to achieve the desired performance and space savings. One such component is an electrical connector, which can be external (e.g., used for power or communication) or internal (e.g., used in computer disk drives or servers, link printed wiring boards, wires, cables and other EEE components). To obtain the desired properties, specific liquid crystalline polymers having certain monomers may be employed and in addition, certain additives may be utilized with the liquid crystalline polymers. Despite the benefits achieved, such compositions have various drawbacks. For example, such compositions may not exhibit the desired dielectric properties. In particular, such compositions may exhibit a relatively high dielectric constant, which can make it difficult to use them in certain applications. Even further, such compositions may not exhibit the desired balance among the dielectric properties, thermal properties, and mechanical properties of the polymer composition. As such, a need exists for a polymer composition that can have a relatively low dielectric constant but still maintain excellent mechanical properties and processability (e.g., low viscosity).

### SUMMARY OF THE INVENTION

In accordance with one embodiment of the present invention, a polymer composition is disclosed that comprises a polyhedral silsesquioxane (POSS) dispersed within a polymer matrix that contains a thermotropic liquid crystalline polymer. The polyhedral silsesquioxane contains an aromatic group. The polymer composition exhibits a dielectric constant of about 4.5 or less as determined at a frequency of 10 GHz.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIGS. 1-2 are respective front and rear perspective views of one embodiment of an electronic component that can employ an antenna system;

FIG. 3 is a top view of an illustrative inverted-F antenna resonating element for one embodiment of an antenna system;

FIG. 4 is a top view of an illustrative monopole antenna resonating element for one embodiment of an antenna system;

FIG. 5 is a top view of an illustrative slot antenna resonating element for one embodiment of an antenna system;

FIG. 6 is a top view of an illustrative patch antenna resonating element for one embodiment of an antenna system;

FIG. 7 is a top view of an illustrative multibranch inverted-F antenna resonating element for one embodiment of an antenna system;

FIG. 8 depicts a 5G antenna system including a base station, one or more relay stations, one or more user computing devices, one or more or more Wi-Fi repeaters according to aspects of the present disclosure;

FIG. 9A illustrates a top-down view of an example user computing device including 5G antennas according to aspects of the present disclosure;

FIG. 9B illustrates a side elevation view of the example user computing device of FIG. 9A including 5G antennas according to aspects of the present disclosure;

FIG. 10 illustrates an enlarged view of a portion of the user computing device of FIG. 9A;

FIG. 11 illustrates a side elevation view of co-planar waveguide antenna array configuration according to aspects of the present disclosure;

FIG. 12A illustrates an antenna array for massive multiple-in-multiple-out configurations according to aspects of the present disclosure;

FIG. 12B illustrates an antenna array formed with laser direct structuring according to aspects of the present disclosure;

FIG. 12C illustrates an example antenna configuration according to aspects of the present disclosure; and

FIGS. 13A through 13C depict simplified sequential diagrams of a laser direct structuring manufacturing process that can be used to form an antenna system.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition containing an aromatic polyhedral silsesquioxane (“POSS”) dispersed within a polymer matrix that includes a liquid crystalline polymer. Without intending to be limited by theory, it is believed that the use of an aromatic POSS molecule (i.e., a molecule containing at least aromatic group) can improve the electric performance of the composition (e.g., reduced dielectric constant) but yet still retain a high degree of compatibility with the liquid crystalline polymer, which is also generally aromatic. Such enhanced compatibility can, among other things, help improve the flow properties and mechanical performance of the resulting polymer composition.

Thus, through careful selection of the particular nature and concentration of the components of the polymer composition, the present inventors have discovered that the resulting composition can exhibit a low dielectric constant over a wide range of frequencies, making it particularly suitable for use in 5G applications. That is, the polymer composition may exhibit a low dielectric constant of about 4.5 or less, in some embodiments about 4 or less, in some embodiments from about 1 to about 4, in some embodiments from about 1.5 to about 3.8, and in some embodiments, from about 2 to about 3.5, as determined by the split post resonator method over typical 5G frequencies (e.g., 2 GHz or 10 GHz). The dissipation factor of the polymer composition, which is a measure of the loss rate of energy, may likewise be about 0.05 or less, in some embodiments about 0.01 or less, in some embodiments from about 0.0001 to about 0.008, and in some embodiments from about 0.0002 to about 0.006 over typical 5G frequencies (e.g., 2 or 10 GHz). In fact, in some cases, the dissipation factor may be very low, such as about 0.003 or less, in some embodiments about 0.002 or less, in some embodiments about 0.001 or less, in some embodiments, about 0.0009 or less, in some embodiments about 0.0008 or less, and in some embodiments, from about 0.0001 to about 0.0007 over typical 5G frequencies (e.g., 2 or 10 GHz). Notably, the present inventors have also surprisingly discovered that the dielectric constant and dissipation factor can be maintained within the ranges noted above even when exposed to various temperatures, such as a temperature of from about −30° C. to about 100° C. For example, when subjected to a heat cycle test as described herein, the ratio of the dielectric constant after heat cycling to the initial dielectric constant may be about 0.8 or more, in some embodiments about 0.9 or more, and in some embodiments, from about 0.91 to about 0.99. Likewise, the ratio of the dissipation after being exposed to the high temperature to the initial dissipation factor may be about 1 or less, in some embodiments about 0.95 or less, in some embodiments from about 0.1 to about 0.9, and in some embodiments, from about to about 0.8. The change in dissipation factor (i.e., the initial dissipation factor—the dissipation factor after heat cycling) may also range from about −0.1 to about in some embodiments from about −0.05 to about 0.01, and in some embodiments, from about −0.001 to 0.

Conventionally, it was believed that polymer compositions exhibiting a low dielectric constant and dissipation factor would not possess sufficiently good thermal, mechanical, and flow properties to enable their use in certain types of applications. Contrary to conventional thought, however, the polymer composition has been found to possess both excellent thermal, mechanical properties, and processability. The melting temperature of the composition may, for instance, be from about 250° C. to about 440° C., in some embodiments from about 270° C. to about 400° C., and in some embodiments, from about 300° C. to about 380° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.55 to about 0.85. The specific DTUL values may, for instance, range from about 170° C. to about 350° C., in some embodiments from about 180° C. to about 320° C., and in some embodiments, from about 190° C. to about 290° C. Such high DTUL values can, among other things, allow the use of high speed and reliable surface mounting processes for mating the structure with other components of an electrical component.

The melt viscosity of the resulting composition is also generally low, which allows it to more readily flow into the cavity of a mold to form a small-sized substrate. For example, in one particular embodiment, the polymer composition may have a melt viscosity of about 100 Pa-s or less, in some embodiments about from about 1 Pa-s to about 60 Pa-s, in some embodiments from about 2 Pa-s to about 50 Pa-s, in some embodiments from about 5 to about 35 Pa-s, as determined at a shear rate of 1,000 seconds⁻¹, as determined at a shear rate of 1,000 seconds⁻¹. Melt viscosity may be determined in accordance with ISO 11443:2021 and at a temperature of about 15° C. greater than the melting temperature of the polymer composition.

The polymer composition may also possess a high impact strength, which is useful when forming thin parts required by many applications. The composition may, for instance, possess a Charpy notched impact strength of about kJ/m 2 or more, in some embodiments from about 15 to about 150 kJ/m², and in some embodiments, from about 30 to about 120 kJ/m², as determined at a temperature of about 23° C. in accordance with ISO 179-1:2010. The tensile and flexural mechanical properties of the composition may also be good. For example, the polymer composition may exhibit a tensile strength of from about 50 to about 500 MPa, in some embodiments from about 100 to about 400 MPa, and in some embodiments, from about 150 to about 350 MPa; a tensile break strain of about 2% or more, in some embodiments from about 3% to about 10%, and in some embodiments, from about 3.3% to about 4.5%; and/or a tensile modulus of from about 5,000 MPa o about 20,000 MPa, in some embodiments from about 6,000 MPa to about 20,000 MPa, and in some embodiments, from about 8,000 MPa to about 20,000 MPa. The tensile properties may be determined at a temperature of about 23° C. in accordance with ISO 527:2019. The polymer composition may also exhibit a flexural strength of from about 20 to about 500 MPa, in some embodiments from about 50 to about 400 MPa, and in some embodiments, from about 100 to about 350 MPa; a flexural elongation of about 0.4% or more, in some embodiments from about 0.5% to about 10%, and in some embodiments, from about 0.6% to about 3.5%; and/or a flexural modulus of from about 5,000 MPa o about 20,000 MPa, in some embodiments from about 8,000 MPa to about 20,000 MPa, and in some embodiments, from about 9,000 MPa to about 15,000 MPa. The flexural properties may be determined at a temperature of about 23° C. in accordance with 178:2019.

Various embodiments of the present invention will now be described in more detail.

### I. Polymer Composition

### A. Polymer Matrix

The polymer matrix typically contains one or more liquid crystalline polymers, generally in an amount of from about 50 wt. % to about 98 wt. %, in some embodiments from about 55 wt. % to about 97 wt. %, and in some embodiments, from about 60 wt. % to about 95 wt. % of the polymer composition. The liquid crystalline polymers are generally classified as “thermotropic” to the extent that they can possess a rod-like structure and exhibit a crystalline behavior in their molten state (e.g., thermotropic nematic state). The polymers may have a relatively high melting temperature, such as about 280° C. or more, n some embodiments from about 280° C. to about 380° C., in some embodiments from about 290° C. to about 350° C., and in some embodiments, from about 300° C. to about 330° C. The melting temperature may be determined as is well known in the art using differential scanning calorimetry (“DSC”), such as determined by ISO 11357-2:2021. Such polymers may be formed from one or more types of repeating units as is known in the art. A liquid crystalline polymer may, for example, contain one or more aromatic ester repeating units generally represented by the following Formula (I):

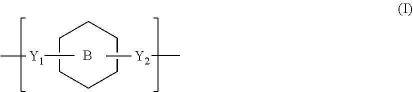

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is 0 and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“NBA”) and 6-hydroxy-2-naphthoic acid (“HNA”). To help achieve the desired properties, the repeating units derived from hydroxycarboxylic acids (e.g., HBA and/or HNA) typically constitute about 30 mol. % or more, in some embodiments about 50 mol. % or more, and in some embodiments, from about 60 mol. % to about 100 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) may each optionally constitute from about 0.1 mol. % to about 30 mol. %, in some embodiments from about 0.2 mol. % to about 25 mol. %, and in some embodiments, from about 0.5 mol. % to about 20% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) may each optionally constitute from about 0.1 mol. % to about 30 mol. %, in some embodiments from about 0.5 mol. % to about 25 mol. %, and in some embodiments, from about 1 mol. % to about 15% of the polymer.

Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) may optionally constitute from about 0.1 mol. % to about 15 mol. %, in some embodiments from about 0.5 mol. % to about 10 mol. %, and in some embodiments, from about 1 mol. % to about 6% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although by no means required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, in some embodiments from about 15 mol. % to about 50 mol. %, and in some embodiments, from 16 mol. % to about 30 mol. % of the polymer. Contrary to many conventional “low naphthenic” polymers, it is believed that the resulting “high naphthenic” polymers are capable of reducing the tendency of the polymer composition to absorb water, which can help stabilize the dielectric constant and dissipation factor at high frequency ranges. Namely, such high naphthenic polymers typically have a water adsorption of about 0.015% or less, in some embodiments about 0.01% or less, and in some embodiments, from about 0.0001% to about 0.008% after being immersed in water for 24 hours in accordance with ISO 62-1:2008. The high naphthenic polymers may also have a moisture adsorption of about 0.01% or less, in some embodiments about 0.008% or less, and in some embodiments, from about 0.0001% to about 0.006% after being exposed to a humid atmosphere (50% relative humidity) at a temperature of 23° C. in accordance with ISO 62-4:2008.

In one embodiment, for instance, the repeating units derived from HNA within the ranges noted above. The liquid crystalline polymer may also contain various other monomers. For example, the polymer may contain repeating units derived from HBA in an amount of from about 50 mol. % to about 100 mol. %, and in some embodiments from about 60 mol. % to about 90 mol. %, and in some embodiments, from about 70 mol. % to about 85 mol. %. The polymer may also contain aromatic dicarboxylic acid(s) (e.g., IA and/or TA) in an amount of from about 0.1 mol. % to about 10 mol. % and/or aromatic diol(s) (e.g., BP and/or HQ) in an amount of from about 0.1 mol. % to about 10 mol. %. Of course, in other embodiments, the liquid crystalline polymer may be a “low naphthenic” polymer to the extent that it contains a relatively low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) may be about 10 mol. % or less, in some embodiments about 8 mol. % or less, and in some embodiments, from about 1 mol. % to about 6 mol. % of the polymer.

Although not required in all instances, it is often desired that a substantial portion of the polymer matrix is formed from such high naphthenic polymers. For example, high naphthenic polymers such as described herein typically constitute 50 wt. % or more, in some embodiments about 65 wt. % or more, in some embodiments from about 70 wt. % to 100 wt. %, and in some embodiments, from about 80 wt. % to 100% of the polymer matrix (e.g., 100 wt. %). In some cases, blends of polymers may also be used. For example, low naphthenic liquid crystalline polymers may constitute from about 1 wt. % to about wt. %, in some embodiments from about 2 wt. % to about 40 wt. %, and in some embodiments, from about 5 wt. % to about 30 wt. % of the total amount of liquid crystalline polymers in the composition, and high naphthenic liquid crystalline polymers may constitute from about 50 wt. % to about 99 wt. %, in some embodiments from about 60 wt. % to about 98 wt. %, and in some embodiments, from about 70 wt. % to about 95 wt. % of the total amount of liquid crystalline polymers in the composition.

### B. Aromatic Polyhedral Silsequioxane

As indicated above, an aromatic polyhedral silsesquioxane (“POSS”) is also employed in the polymer composition. Such aromatic POSS molecules typically constitute from about 0.1 to about 20 parts by weight, in some embodiments from about 0.5 to about 15 parts by weight, and in some embodiments, from about 1 to about 10 parts by weight per 100 parts by weight of the polymer matrix. For instance, aromatic POSS molecules may constitute from about 0.01 wt. % to about 20 wt. %, in some embodiments from about 0.1 wt. % to about 15 wt. %, and in some embodiments, from about 0.5 wt. % to about 10 w. % of the polymer composition.

Polyhedral silsesquioxanes have the generic formula (RSiO_{1.5})ₙ wherein R is an organic moiety and n is 6, 8, 10, 12, or higher. Suitable organic moieties may include, for instance, hydrogen, siloxy, alkyl, alkene, aryl, arylene, silene, methyl, ethyl, iso-butyl, iso-octyl, phenyl, cyclic or linear aliphatic or aromatic groups, acrylate, methacrylate, epoxy, vinyl, fluoro-alkyl, alcohol, ester, amine, ketone, olefin, ether, halide, thiol, carboxylic acid, norbornenyl, sulphonic acid, polyethylene glycol, polyethylene oxalate, or other desired organic groups. Nevertheless, at least one of the organic moieties contains an aromatic group, which may optionally be substituted. Suitable aromatic groups may, for instance, include those having from 3 to 14 carbon atoms and no ring heteroatoms (e.g., single ring aromatics, such as phenyl, or multiple condensed (fused) rings, such as naphthyl or anthryl), as well those having from 1 to 14 carbon atoms and 1 to 6 heteroatoms selected from oxygen, nitrogen, and sulfur (e.g., single ring aromatics, such as imidazoyl, or multiple condensed (fused) rings, such as benzimidazol-2-yl or benzimidazol-6-yl). The aromatic POSS may be either homoleptic or heteroleptic. Homoleptic systems generally contain only one type of R group, while heteroleptic systems generally contain more than one type of R group. POSS molecules may thus be represented by the formulae: [(RSiO_{1.5})ₙ] for homoleptic compositions, [(RSiO_{1.5})ₘ(R′SiO_{1.5})ₙ] for heteroleptic compositions (where R and R′ and different), and [(RSiO_{1.5})ₘ(RXSiO_{1.0})ₙ] for functionalized heteroleptic compositions (where the R groups can be the same or different and X is a linking group).

In certain embodiments, the aromatic POSS molecule may be a homoleptic system in which each R group is an aromatic group (e.g., optionally substituted phenyl). Examples of such homoleptic, aromatic POSS molecules may include, for instance, octaphenyl-POSS, dodecaphenyl-POSS, and polyphenyl-POSS. Dodecaphenyl-POSS, for instance, has a general formula of [RSiO_{1.5}]₁₂ and the structure noted below:

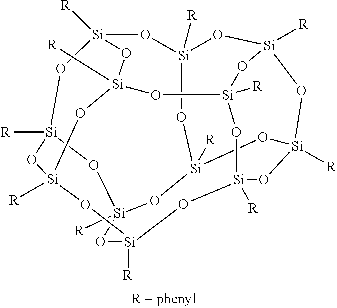

Octaphenyl-POSS likewise has a general formula of [RSiO_{1.5}]₈ and the structure noted below:

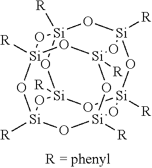

In other embodiments, the aromatic POSS molecule may be a heteroleptic system in which one or more R groups are an aromatic group (e.g., optionally substituted phenyl) and one or more R groups are functionalized organic groups. One example of such an aromatic POSS molecule is one having the following general formula:

Rₙ₋ₘ[SiO_{1.5}]ₙYₘ

wherein,
R is an aromatic group (e.g., phenyl);
n is 6, 8, 10, 12 or higher;
m is 1 to n; and
Y is an organic group containing a functional group, such as a halide, alcohol, amine, isocyanate, acid, acid chloride, silanol, silane, acrylate, methacrylate, olefin, epoxide, or a combination thereof.

In one particularly suitable embodiment, n is 8 and m is 1, 2, or 3. Y may be an aromatic group (e.g., optionally substituted phenyl) containing a functional group. Specific examples of such molecules may include, for instance, trisnorbornenylisobutyl-POSS, trisilanolisooctyl-POSS, trisilanolphenyl-POSS, trisilanolisobutyl-POSS, trisilanolcyclopentyl-POSS, trisilanolcyclohexyl-POSS. Trisilanolphenyl-POSS, for instance, has the structure noted below (where R=phenyl):

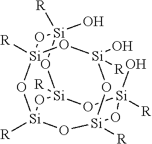

Such molecules may be formed by corner-capping an incompletely condensed POSS containing trisilanol groups with a substituted trichlorosilane to produce a fully condensed POSS molecule.

### C. Other Components

i. Laser Activatable Additive

Although by no means required, the polymer composition may be “laser activatable” in the sense that it contains an additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). When employed, laser activatable additives typically constitute from about 0.1 wt. % to about 20 wt. %, in some embodiments from about 0.5 wt. % to about 15 wt. %, and in some embodiments, from about 1 wt. % to about 10 wt. % of the polymer composition. The laser activatable additive generally includes spinel crystals, which may include two or more metal oxide cluster configurations within a definable crystal formation. For example, the overall crystal formation may have the following general formula:

AB₂O₄

wherein,
A is a metal cation having a valance of 2, such as cadmium, chromium, manganese, nickel, zinc, copper, cobalt, iron, magnesium, tin, titanium, etc., as well as combinations thereof; and
B is a metal cation having a valance of 3, such as chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable spinel crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, etc. Copper chromium oxide (CuCr₂O₄) is particularly suitable for use in the present invention and is available from Shepherd Color Co. under the designation “Shepherd Black 1GM.”

ii. Fibrous Filler

A fibrous filler may also be employed in the polymer composition to improve the thermal and mechanical properties of the composition without having a significant impact on electrical performance. To help maintain the desired dielectric properties, such high strength fibers may be formed from materials that are generally insulative in nature, such as glass, ceramics (e.g., alumina or silica), aramids (e.g., Kevlar® marketed by E. I. du Pont de Nemours, Wilmington, Del.), polyolefins, polyesters, etc. Glass fibers are particularly suitable, such as E-glass, A-glass, C-glass, D-glass, AR-glass, R-glass, S1-glass, S2-glass, etc.

Although the fibers employed in the fibrous filler may have a variety of different sizes, fibers having a certain aspect ratio can help improve the mechanical properties of the resulting polymer composition. That is, fibers having an aspect ratio (average length divided by nominal diameter) of about 2 or more, in some embodiments about 4 or more, in some embodiments from about 5 to about 50, and in some embodiments, from about 8 to about 40 are particularly beneficial. Such fibrous fillers may, for instance, have a weight average length of about 10 micrometer or more, in some embodiments about 25 micrometers or more, in some embodiments from about 50 micrometers or more to about 800 micrometers or less, and in some embodiments from about 60 micrometers to about 500 micrometers. Also, such fibrous fillers may, for instance, have a volume average length of about 10 micrometer or more, in some embodiments about 25 micrometers or more, in some embodiments from about 50 micrometers or more to about 800 micrometers or less, and in some embodiments from about 60 micrometers to about 500 micrometers. The fibrous fillers may likewise have a nominal diameter of about 5 micrometers or more, in some embodiments about 6 micrometers or more, in some embodiments from about 8 micrometers to about 40 micrometers, and in some embodiments from about 9 micrometers to about 20 micrometers. The relative amount of the fibrous filler may also be selectively controlled to help achieve the desired mechanical and thermal properties without adversely impacting other properties of the composition, such as its flowability and dielectric properties, etc. For example, the fibrous filler may be employed in a sufficient amount so that the weight ratio of the fibrous filler to any optional laser activatable additive is from about 1 to about 5, in some embodiments from about 1.5 about 4.5, and in some embodiments from about 2 to about 3.5. The fibrous filler may, for instance, constitute from about 1 wt. % to about 40 wt. %, in some embodiments from about 3 wt. % to about 30 wt. %, and in some embodiments, from about 5 wt. % to about 20 wt. % of the polymer composition.

iii. Hydrophobic Material

If desired, a hydrophobic material may be employed in the polymer composition to help further reduce its tendency to absorb water, which can help stabilize the dielectric constant and dissipation factor at high frequency ranges. When employed, the weight ratio of liquid crystalline polymer(s) to hydrophobic material(s) is typically from about 1 to about 20, in some embodiments from about 2 to about 15, and in some embodiments, from about 3 to about 10. For example, the hydrophobic material may constitute from about 1 wt. % to about 60 wt. %, in some embodiments from about 2 wt. % to about 50 wt. %, and in some embodiments, from about 5 wt. % to about 40 wt. % of the entire polymer composition.

Particularly suitable hydrophobic materials are low surface energy elastomers, such as fluoropolymers, silicone polymers, etc. Fluoropolymers, for instance, may contains a hydrocarbon backbone polymer in which some or all of the hydrogen atoms are substituted with fluorine atoms. The backbone polymer may polyolefinic and formed from fluorine-substituted, unsaturated olefin monomers. The fluoropolymer can be a homopolymer of such fluorine-substituted monomers or a copolymer of fluorine-substituted monomers or mixtures of fluorine-substituted monomers and non-fluorine-substituted monomers. Along with fluorine atoms, the fluoropolymer can also be substituted with other halogen atoms, such as chlorine and bromine atoms. Representative monomers suitable for forming fluoropolymers for use in this invention are tetrafluoroethylene (“TFE”), vinylidene fluoride (“VF2”), hexafluoropropylene (“HFP”), chlorotrifluoroethylene (“CTFE”), perfluoroethylvinyl ether (“PEVE”), perfluoromethylvinyl ether (“PMVE”), perfluoropropylvinyl ether (“PPVE”), etc., as well as mixtures thereof. Specific examples of suitable fluoropolymers include polytetrafluoroethylene (“PTFE”), perfluoroalkylvinyl ether (“PVE”), poly(tetrafluoroethylene-co-perfluoroalkyvinyl ether) (“PFA”), fluorinated ethylene-propylene copolymer (“FEP”), ethylene-tetrafluoroethylene copolymer (“ETFE”), polyvinylidene fluoride (“PVDF”), polychlorotrifluoroethylene (“PCTFE”), and TFE copolymers with VF2 and/or HFP, etc., as well as mixtures thereof.

In certain embodiments, the hydrophobic material (e.g., fluoropolymer) may have a particle size that is selectively controlled to help form films of a relatively low thickness. For example, the hydrophobic material may have a median particle size (e.g., diameter) of about 1 to about 60 micrometers, in some embodiments from about 2 to about 55 micrometers, in some embodiments from about 3 to about 50 micrometers, and in some embodiments, from about 25 to about 50 micrometers, such as determined using laser diffraction techniques in accordance with ISO 13320:2009 (e.g., with a Horiba LA-960 particle size distribution analyzer). The hydrophobic material may also have a narrow size distribution. That is, at least about 70% by volume of the particles, in some embodiments at least about 80% by volume of the particles, and in some embodiments, at least about 90% by volume of the particles may have a size within the ranges noted above.

iv. Particulate Filler

If desired, a particulate filler may be employed for improving certain properties of the polymer composition. The particulate filler may be employed in the polymer composition in an amount of from about 5 to about 60 parts, in some embodiments from about 10 to about 50 parts, and in some embodiments, from about 15 to about 40 parts by weight per 100 parts of the liquid crystalline polymer(s) employed in the polymer composition. For instance, the particulate filler may constitute from about 5 wt. % to about 50 wt. %, in some embodiments from about 10 wt. % to about 40 wt. %, and in some embodiments, from about 15 wt. % to about 30 wt. % of the polymer composition.

In certain embodiments, particles may be employed that have a certain hardness value to help improve the surface properties of the composition. For instance, the hardness values may be about 2 or more, in some embodiments about 2.5 or more, in some embodiments from about 3 to about 11, in some embodiments from about 3.5 to about 11, and in some embodiments, from about 4.5 to about 6.5 based on the Mohs hardness scale. Examples of such particles may include, for instance, silica (Mohs hardness of 7), mica (e.g., Mohs hardness of about 3); carbonates, such as calcium carbonate (CaCO₃, Mohs hardness of 3.0) or a copper carbonate hydroxide (Cu₂CO₃(OH)₂, Mohs hardness of 4.0); fluorides, such as calcium fluoride (CaFl₂, Mohs hardness of 4.0); phosphates, such as calcium pyrophosphate ((Ca₂P₂O₇, Mohs hardness of 5.0), anhydrous dicalcium phosphate (CaHPO₄, Mohs hardness of 3.5), or hydrated aluminum phosphate (AIPO_{4.2}H2O, Mohs hardness of 4.5); borates, such as calcium borosilicate hydroxide (Ca₂B₅SiO₉(OH)₅, Mohs hardness of 3.5); alumina (AlO₂, Mohs hardness of 10.0); sulfates, such as calcium sulfate (CaSO₄, Mohs hardness of 3.5) or barium sulfate (BaSO₄, Mohs hardness of from 3 to 3.5); and so forth, as well as combinations thereof.

The shape of the particles may vary as desired. For instance, flake-shaped particles may be employed in certain embodiments that have a relatively high aspect ratio (e.g., average diameter divided by average thickness), such as about 10:1 or more, in some embodiments about 20:1 or more, and in some embodiments, from about 40:1 to about 200:1. The average diameter of the particles may, for example, range from about 5 micrometers to about 200 micrometers, in some embodiments from about 30 micrometers to about 150 micrometers, and in some embodiments, from about 50 micrometers to about 120 micrometers, such as determined using laser diffraction techniques in accordance with ISO 13320:2009 (e.g., with a Horiba LA-960 particle size distribution analyzer). Suitable flaked-shaped particles may be formed from a natural and/or synthetic silicate mineral, such as mica, halloysite, kaolinite, illite, montmorillonite, vermiculite, palygorskite, pyrophyllite, calcium silicate, aluminum silicate, wollastonite, etc. Mica, for instance, is particularly suitable. Any form of mica may generally be employed, including, for instance, muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃ (AlSi₃)O₁₀(OH)₂), glauconite (K,Na)(AI,Mg,Fe)₂(Si,Al)₄O₁₀(OH)₂), etc. Granular particles may also be employed. Typically, such particles have an average diameter of from about 0.1 to about 10 micrometers, in some embodiments from about 0.2 to about 4 micrometers, and in some embodiments, from about 0.5 to about 2 micrometers, such as determined using laser diffraction techniques in accordance with ISO 13320:2009 (e.g., with a Horiba LA-960 particle size distribution analyzer). Particularly suitable granular fillers may include, for instance, talc, barium sulfate, calcium sulfate, calcium carbonate, etc.

The particulate filler may be formed primarily or entirely from one type of particle, such as flake-shaped particles (e.g., mica) or granular particles (e.g., barium sulfate). That is, such flaked-shaped or granular particles may constitute about 50 wt. % or more, and in some embodiments, about 75 wt. % or more (e.g., 100 wt. %) of the particulate filler. Of course, in other embodiments, flake-shaped and granular particles may also be employed in combination. In such embodiments, for example, flake-shaped particles may constitute from about 0.5 wt. % to about 20 wt. %, and in some embodiments, from about 1 wt. % to about 10 wt. % of the particulate filler, while the granular particles constitute from about 80 wt. % to about 99.5 wt. %, and in some embodiments, from about 90 wt. % to about 99 wt. % of the particulate filler.

If desired, the particles may also be coated with a fluorinated additive to help improve the processing of the composition, such as by providing better mold filling, internal lubrication, mold release, etc. The fluorinated additive may include a fluoropolymer, which contains a hydrocarbon backbone polymer in which some or all of the hydrogen atoms are substituted with fluorine atoms. The backbone polymer may polyolefinic and formed from fluorine-substituted, unsaturated olefin monomers. The fluoropolymer can be a homopolymer of such fluorine-substituted monomers or a copolymer of fluorine-substituted monomers or mixtures of fluorine-substituted monomers and non-fluorine-substituted monomers. Along with fluorine atoms, the fluoropolymer can also be substituted with other halogen atoms, such as chlorine and bromine atoms. Representative monomers suitable for forming fluoropolymers for use in this invention are tetrafluoroethylene, vinylidene fluoride, hexafluoropropylene, chlorotrifluoroethylene, perfluoroethylvinyl ether, perfluoromethylvinyl ether, perfluoropropylvinyl ether, etc., as well as mixtures thereof. Specific examples of suitable fluoropolymers include polytetrafluoroethylene, perfluoroalkylvinyl ether, poly(tetrafluoroethylene-co-perfluoroalkyvinylether), fluorinated ethylene-propylene copolymer, ethylene-tetrafluoroethylene copolymer, polyvinylidene fluoride, polychlorotrifluoroethylene, etc., as well as mixtures thereof.

v. Electrically Conductive Material

If desired, electrically conductive materials may also be employed to help improve various electrical properties of the composition. Such materials may, for example, be employed to lower the electrical resistivity of the composition. The surface resistivity may, for instance, be about 1×10¹² ohms or less, in some embodiments about 1×10¹⁰ ohms or less, in some embodiments about 1×10⁷ ohms or less, and in some embodiments, from about 1×10³ to about 1×10⁶ ohms, such as determined at a temperature of about 20° C. in accordance with IEC 62631-3-2:2016. The volume resistivity may likewise be about 1×10⁷ ohm-m or less, in some embodiments about 1×10⁶ ohm-m or less, in some embodiments about 1×10⁵ ohm-m or less, and in some embodiments, from about 1×10² to about 1×10⁴ ohm-m, such as determined at a temperature of about 20° C. in accordance with IEC 62631-3-1:2016.

In certain embodiments, the low resistivity of the composition may help improve the electromagnetic interference (“EMI”) properties of the composition. For example, the polymer composition may exhibit an EMI shielding effectiveness (“SE”) of about 40 decibels (dB) or more, in some embodiments about 45 dB or more, in some embodiments about 50 dB or more, and in some embodiments, from about 55 dB to about 200 dB, as determined in accordance with ASTM D4935-18 at a high frequency, such as 6 GHz. The EMI shielding effectiveness may remain stable over a high frequency range, such as about 700 MHz or more, in some embodiments from about 1 GHz to about 100 GHz, and in some embodiments, from about 2 GHz to about 18 GHz. The EMI shielding effectiveness may also be within the desired range for a variety of different part thicknesses, such as from about 0.5 to about 10 millimeters, in some embodiments from about 0.8 to about 5 millimeters, and in some embodiments, from about 1 to about 4 millimeters (e.g., 1 millimeter, 1.6 millimeters, or 3 millimeters). Within these high frequency and/or thickness ranges, for example, the average EMI shielding effectiveness may be about 40 dB or more, in some embodiments about dB or more, and in some embodiments, from about 50 dB to about 200 dB. Likewise, the minimum EMI shielding effectiveness may be about 10 dB or more, in some embodiments about 15 dB or more, and in some embodiments, from about 20 dB to about 100 dB. The composition may also have good EMI shielding effectiveness at lower frequencies, such as from 200 MHz to 1.5 GHz. For example, within these lower frequency ranges and the thickness ranges noted above, the average EMI shielding effectiveness may be about 50 dB or more, in some embodiments about 55 dB or more, and in some embodiments, from about dB to about 200 dB.

When employed, the electrically conductive material typically constitutes from about 0.1 parts to about 10 parts by weight, in some embodiments from about 0.2 parts to about 6 parts by weight, and in some embodiments, from about 0.5 parts to about 2.5 parts by weight per 100 parts by weight of the polymer matrix. For example, the electrically conductive material may constitute from about 0.1 wt % to about 5 wt %, in some embodiments from about 0.2 wt. % to about 3 wt,%, and in some embodiments, from about 0.4 wt % to about 1.5 wt % of the polymer composition.

Suitable electrically conductive materials may include, for instance, electrically conductive carbon materials (e.g., graphite, carbon black, fibers, graphene, nanotubes, carbon nanostructures, etc.), metals, etc. In one particular embodiment, for instance, the electrically conductive material may include carbon nanostructures. The carbon nanostructures generally include carbon nanotubes that are optionally disposed on a substrate and arranged in a network having a web-like morphology in that at least a portion of the carbon nanotubes are branched, crosslinked, interdigitated, share common walls with one another, and so forth. It should be understood that every carbon nanotube does not necessarily have the foregoing structural features. Rather, the carbon nanotubes as a whole can possess one or more of these structural features. For example, in some embodiments, a portion of the carbon nanotubes may be branched, another portion of the carbon nanotubes may be crosslinked, and yet another portion of the carbon nanotubes may share common walls. Likewise, in some embodiments, at least a portion of the carbon nanotubes can be interdigitated with one another and/or with branched, crosslinked, or common-wall carbon nanotubes in the remainder of the carbon nanostructure.

The web-like morphology of the carbon nanostructure can result in a low bulk density. For example, as-produced carbon nanostructures can have an initial bulk density ranging between about 0.003 g/cm³ to about 0.015 g/cm³. Further consolidation and/or coating to produce a flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further altered by forming a coating on the carbon nanotubes and/or infiltrating the interior of the carbon nanostructure with various materials. Coating the carbon nanotubes and/or infiltrating the interior of the carbon nanostructure can further tailor the properties of the carbon nanostructure for use in various applications. Moreover, in some embodiments, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

Various techniques may be employed to form the carbon nanostructures. In one embodiment, for instance, carbon nanotubes may be formed (e.g., grown, infused, etc.) on a substrate. Depending on the desired form of the nanostructures, the carbon nanotubes may be separated from the substrate or remain thereon. Examples of techniques for growing the nanotubes on a substrate are described, for example, in U.S. Patent Application Publication No. 2014/0093728, as well as U.S. Pat. Nos. 8,784,937; 9,005,755; 9,107,292; 9,241,433; and 9,447,259, all of which are incorporated herein in their entirety by reference thereto. Without intending to be limited by theory, it is believed that the use of a substrate can help form the complex, web-like morphology due to the ability of carbon nanotubes to grow at a rapid rate, such as on the order of several micrometers per second. The rapid carbon nanotube growth rate, coupled with the close proximity of the carbon nanotubes to one another, can confer the observed branching, crosslinking, and shared wall motifs to the carbon nanotubes. As used herein, the “carbon nanotubes” employed in the nanostructures are generally any number of cylindrically-shaped allotropes of carbon of the fullerene family and include single-walled carbon nanotubes (SWNTs), double-walled carbon nanotubes (DWNTs), multi-walled carbon nanotubes (MWNTs), etc., as well as combinations thereof. The carbon nanotubes can be capped by a fullerene-like structure or open-ended, and may include those that encapsulate other materials. SWCNTs can be thought of as an allotrope of sp2-hybridized carbon similar to fullerenes. The structure is a cylindrical tube including six-membered carbon rings. Analogous MWCNTs, on the other hand, have several tubes in concentric cylinders. The number of these concentric walls may vary, such as from 2 to 25 or more. Typically, the diameter of MWNTs may be 10 nm or more, in comparison to to 2.0 nm for typical SWNTs. It is typically desired that the carbon nanostructures employed in the polymer composition are formed from MWCNTs, such as those having at least two coaxial carbon nanotubes. The number of walls present, as determined, for example, by transmission electron microscopy (TEM), at a magnification sufficient for analyzing the number of wall in a particular case, can be within the range of from 2 to 30, in some embodiments, from 4 to 28, in some embodiments from 5 to 26, and in some embodiments, from 6 to 24. Carbon nanotubes present in or derived from the carbon nanostructures typically has a typical diameter of 100 nanometers or less, in some embodiments from about 5 to about 90 nanometers, and in some embodiments, from about 10 to about 30 nanometers. The carbon nanotubes may also have a length of about 2 micrometers or more, in some embodiments from about 2 to about 10 micrometers, and in some embodiments, from about 2.5 to about 5 micrometers. The aspect ratio of the carbon nanotubes may also be relatively high, such as from about 200 to about 1,000, in some embodiments from about 300 to about 900, and in some embodiments, from about 400 to about 800.

vi. Other Additives

A wide variety of additional additives can also be included in the polymer composition, such as lubricants, thermally conductive fillers, pigments, antioxidants, stabilizers, surfactants, waxes, flame retardants, anti-drip additives, nucleating agents (e.g., boron nitride), flow modifiers (e.g., aluminum trihydroxide), dielectric materials, and other materials added to enhance properties and processability. Suitable thermally conductive fillers may include, for instance, carbon black, alumina, boron nitride, silica, carbon fibers, graphene, graphene oxide, graphite (e.g., expanded graphite, synthesized graphite, low-temperature expanded graphite, and the like), aluminum nitride, silicon nitride, metal oxide (such as, for example, zinc oxide, magnesium oxide, beryllium oxide, titanium oxide, zirconium oxide, yttrium oxide, and the like), nano-diamonds, carbon nanotubes, which may be the same or different than those described above, calcium carbonate, talc, mica, wollastonite, clays (including exfoliated clays), metal powders (such as, for example, aluminum, copper, bronze, brass, and the like), or mixtures thereof. In certain embodiments, for example, the thermally conductive filler may include carbon fibers.

Flow modifiers may also be employed to help achieve the desired melt viscosity for the composition. When employed, such flow modifiers are typically present in an amount of from about 0.05 to about 5 parts, in some embodiments from about 0.1 to about 1 part, and in some embodiments, from about 0.2 to about 1 part by weight relative to 100 parts by weight of the liquid crystalline polymer(s). For example, the flow modifier may constitute from about 0.01 wt. % to about 5 wt. %, in some embodiments from about 0.05 wt. % to about 3 wt. %, and in some embodiments, from about 0.1 wt. % to about 1 wt. % of the polymer composition.

If desired, the liquid crystalline polymer(s) may be melt processed in the presence of a flow modifier to help achieve the desired low melt viscosity without sacrificing other properties of the composition. In such instances, the flow modifier may be a compound that contains one or more functional groups (e.g., hydroxyl, carboxyl, etc.). The term “functional” generally means that the compound contains at least one functional group (e.g., carboxyl, hydroxyl, etc.) or is capable of possessing such a functional group in the presence of a solvent. The functional compounds used herein may be mono-, di-, tri-functional, etc. The total molecular weight of the compound is relatively low so that it so that it can effectively serve as a flow modifier for the polymer composition. The compound typically has a molecular weight of from about 2,000 grams per mole or less, in some embodiments from about 25 to about 1,000 grams per mole, in some embodiments from about 50 to about 500 grams per mole, and in some embodiments, from about 100 to about 400 grams per mole. Any of a variety of functional compounds may generally be employed. In certain embodiments, a metal hydroxide compound may be employed that has the general formula M(OH)ₛ, where s is the oxidation state (typically from 1 to 3) and M is a metal, such as a transitional metal, alkali metal, alkaline earth metal, or main group metal. Without intending to be limited by theory, it is believed that such compounds can effectively “lose” water under the process conditions (e.g., high temperature), which can assist in melt viscosity reduction. Examples of suitable metal hydroxides may include copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. Also suitable are metal alkoxide compounds that are capable of forming a hydroxyl functional group in the presence of a solvent, such as water. Such compounds may have the general formula M(OR)ₛ, wherein s is the oxidation state (typically from 1 to 3), M is a metal, and R is alkyl. Examples of such metal alkoxides may include copper (II) ethoxide (Cu²⁺(CH₃CH₂O⁻)₂), potassium ethoxide (K⁺(CH₃CH₂O⁻)), sodium ethoxide (Na⁺(CH₃CH₂O⁻)), magnesium ethoxide (Mg²⁺(CH₃CH₂O⁻)₂), calcium ethoxide (Ca²⁺(CH₃CH₂O⁻)₂), etc.; aluminum ethoxide (Al³⁺(CH₃CH₂O⁻)₃), and so forth. Besides metal hydroxides, metal salt hydrates may also employed, which are typically represented by the formula MA*xH₂O, wherein M is a metal cation, A is an anion, and x is from 1 to 20, and in some embodiments, from 2 to 10. Specific examples of such hydrates may include, for instance, CaCl₂)H₂O, ZnCl₂·4H₂O, CoCl₂·6H₂O, CaSO₄·2H₂O, MgSO₄·7H₂O, CuSO₄·5H₂O, Na₂SO₄·10H₂O, Na₂CO₃·10H₂O, Na₂B₄O₇·10H₂O and Ba(OH)₂·8H₂O.

### II. Formation

Regardless of the ingredients employed, the aromatic polyhedral silsequioxane and other optional components may be melt processed or blended together with the liquid crystalline polymer(s) in the composition. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/rrR³, where Q is the volumetric flow rate (“m³/s”) of the polymer melt and R is the radius (“m”) of the capillary (e.g., extruder die) through which the melted polymer flows.

### III. Parts

Once formed, the polymer composition may be molded into a desired shape for a particular application. Due to the beneficial properties of the polymer composition, the resulting part may have a very small size, such as a thickness of about 5 millimeters or less, in some embodiments about 4 millimeters or less, and in some embodiments, from about 0.1 to about 3 millimeters. Typically, the shaped parts are molded using a one-component injection molding process in which dried and preheated plastic granules are injected into the mold.

In certain cases, the shaped part may be in the form of a substrate on which one or more conductive elements may be disposed for a variety of purposes. The conductive elements may be formed in a variety of ways, such as by plating, electroplating, laser direct structuring, etc. When containing spinel crystals as a laser activatable additive, for instance, activation with a laser may cause a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization. If desired, the conductive elements may be antenna elements (e.g., antenna resonating elements) so that the resulting part forms an antenna system. The conductive elements can form antennas of a variety of different types, such as antennae with resonating elements that are formed from patch antenna elements, inverted-F antenna elements, closed and open slot antenna elements, loop antenna elements, monopoles, dipoles, planar inverted-F antenna elements, hybrids of these designs, etc. The resulting antenna system can be employed in a variety of different electronic components. As an example, the antenna system may be formed in electronic components, such as desktop computers, portable computers, handheld electronic devices, automotive equipment, etc. In one suitable configuration, the antenna system is formed in the housing of a relatively compact portable electronic component in which the available interior space is relatively small. Examples of suitable portable electronic components include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. The antenna could also be integrated with other components such as camera module, speaker or battery cover of a handheld device.

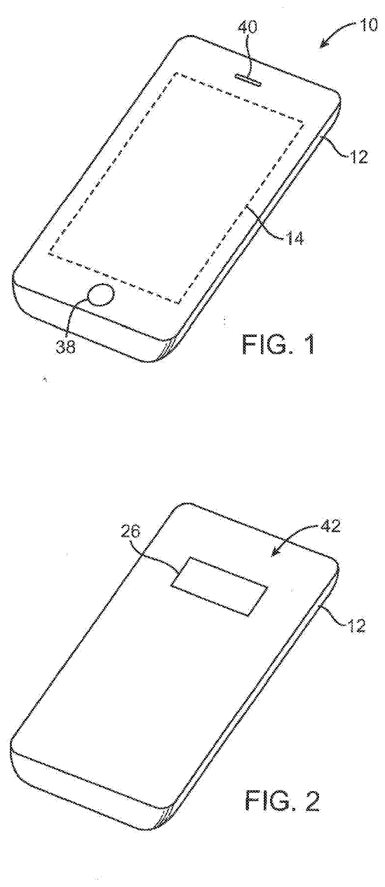

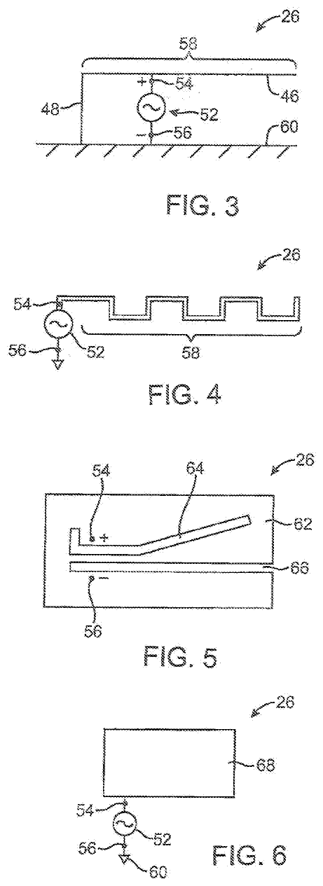

One particularly suitable electronic component is shown in FIGS. 1-2 is a handheld device 10 with cellular telephone capabilities. As shown in FIG. 1, the device 10 may have a housing 12 formed from plastic, metal, other suitable dielectric materials, other suitable conductive materials, or combinations of such materials. A display 14 may be provided on a front surface of the device 10, such as a touch screen display. The device 10 may also have a speaker port 40 and other input-output ports. One or more buttons 38 and other user input devices may be used to gather user input. As shown in FIG. 2, an antenna system 26 is also provided on a rear surface 42 of device 10, although it should be understood that the antenna system can generally be positioned at any desired location of the device. The antenna system may be electrically connected to other components within the electronic device using any of a variety of known techniques. Referring again to FIGS. 1-2, for example, the housing 12 or a part of housing 12 may serve as a conductive ground plane for the antenna system 26. This is more particularly illustrated in FIG. 3, which shows the antenna system 26 as being fed by a radio-frequency source 52 at a positive antenna feed terminal 54 and a ground antenna feed terminal 56. The positive antenna feed terminal 54 may be coupled to an antenna resonating element 58, and the ground antenna feed terminal 56 may be coupled to a ground element 60. The resonating element 58 may have a main arm 46 and a shorting branch 48 that connects main arm 46 to ground 60.

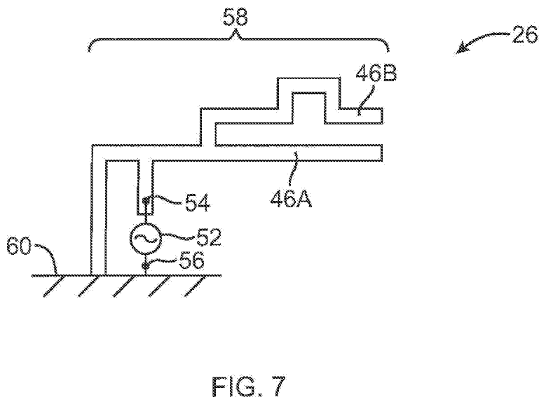

Various other configurations for electrically connecting the antenna system are also contemplated. In FIG. 4, for instance, the antenna system is based on a monopole antenna configuration and the resonating element 58 has a meandering serpentine path shape. In such embodiments, the feed terminal 54 may be connected to one end of resonating element 58, and the ground feed terminal 56 may be coupled to housing 12 or another suitable ground plane element. In another embodiment as shown in FIG. 5, conductive antenna elements 62 are configured to define a closed slot 64 and an open slot 66. The antenna formed from structures 62 may be fed using positive antenna feed terminal 54 and ground antenna feed terminal 56. In this type of arrangement, slots 64 and 66 serve as antenna resonating elements for the antenna element 26. The sizes of the slots 64 and 66 may be configured so that the antenna element 26 operates in desired communications bands (e.g., 2.4 GHz and 5 GHz, etc.). Another possible configuration for the antenna system 26 is shown in FIG. 6. In this embodiment, the antenna element 26 has a patch antenna resonating element 68 and may be fed using positive antenna feed terminal 54 and ground antenna feed terminal 56. The ground 60 may be associated with housing 12 or other suitable ground plane elements in device 10. FIG. 7 shows yet another illustrative configuration that may be used for the antenna elements of the antenna system 26. As shown, antenna resonating element 58 has two main arms 46A and 46B. The arm 46A is shorter than the arm 46B and is therefore associated with higher frequencies of operation than the arm 46A. By using two or more separate resonating element structures of different sizes, the antenna resonating element 58 can be configured to cover a wider bandwidth or more than a single communications band of interest.

In certain embodiments of the present invention, the polymer composition may be particularly well suited for high frequency antennas and antenna arrays for use in base stations, repeaters (e.g., “femtocells”), relay stations, terminals, user devices, and/or other suitable components of 5G systems. As used herein, “5G” generally refers to high speed data communication over radio frequency signals. 5G networks and systems are capable of communicating data at much faster rates than previous generations of data communication standards (e.g., “4G, “LTE”). For example, as used herein, “5G frequencies” can refer to frequencies that are 1.5 GHz or more, in some embodiments about 2.0 GHz or more, in some embodiments about 2.5 GHz or higher, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz. Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. Antenna systems described herein can satisfy or qualify as “5G” under standards released by 3GPP, such as Release 15 (2018), and/or the IMT-2020 Standard.

To achieve high speed data communication at high frequencies, antenna elements and arrays may employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate dielectric on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO).

The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, and the like. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements can have a variety of configurations and arrangements and can be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may be employed within the scope of this disclosure.

As a result of such small feature dimensions, antenna systems can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

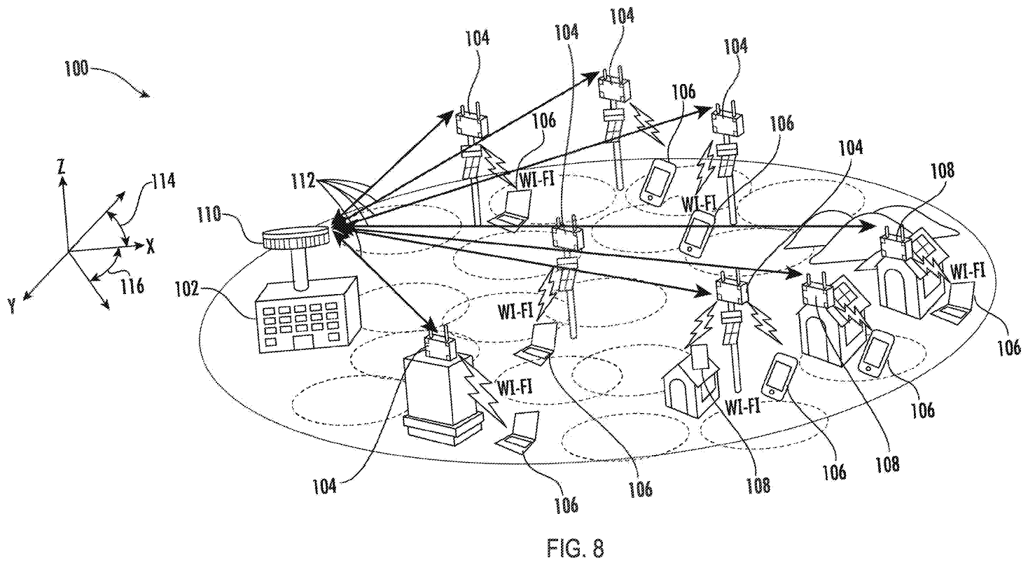

Referring to FIG. 8, one embodiment of a 5G antenna system 100 is shown that also includes a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and include devices such as 5G smartphones.

The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

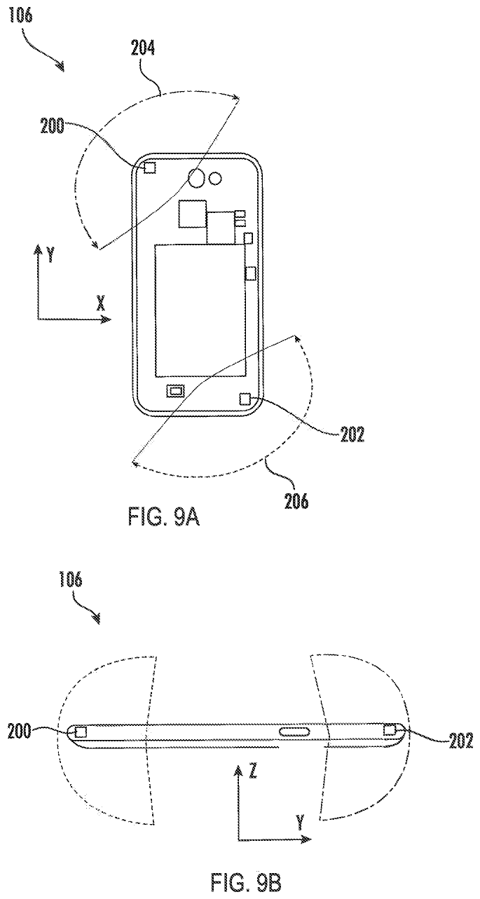

FIGS. 9A and 9B illustrate a top-down and side elevation view, respectively, of an example user computing device 106. The user computing device 106 may include one or more antenna elements 200, 202 (e.g., arranged as respective antenna arrays). Referring to FIG. 9A, the antenna elements 200, 202 can be configured to perform beam steering in the X-Y plane (as illustrated by arrows 204, 206 and corresponding with a relative azimuth angle). Referring to FIG. 9B, the antenna elements 200, 202 can be configured to perform beam steering in the Z-Y plane (as illustrated by arrows 204, 206).

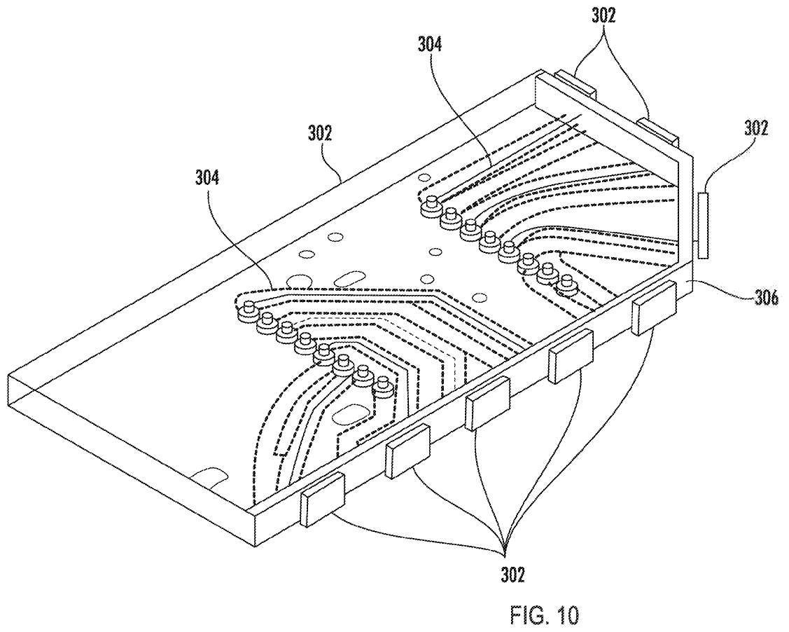

FIG. 10 depicts a simplified schematic view of a plurality of antenna arrays 302 connected using respective feed lines 304 (e.g., with a front end module). The antenna arrays 302 can be mounted to a side surface 306 of a substrate 308, which may be formed from the polymer composition of the present invention. The antenna arrays 302 can include a plurality of vertically connected elements (e.g., as a mesh-grid array). Thus, the antenna array 302 can generally extend parallel with the side surface 306 of the substrate 308. Shielding can optionally be provided on the side surface 306 of the substrate 308 such that the antenna arrays 302 are located outside of the shielding with respect to the substrate 308. The vertical spacing distance between the vertically connected elements of the antenna array 302 can correspond with the “feature sizes” of the antenna arrays 320. As such, in some embodiments, these spacing distances may be relatively small (e.g., less than about 750 micrometers) such that the antenna array 302 is a “fine pitch” antenna array 302.

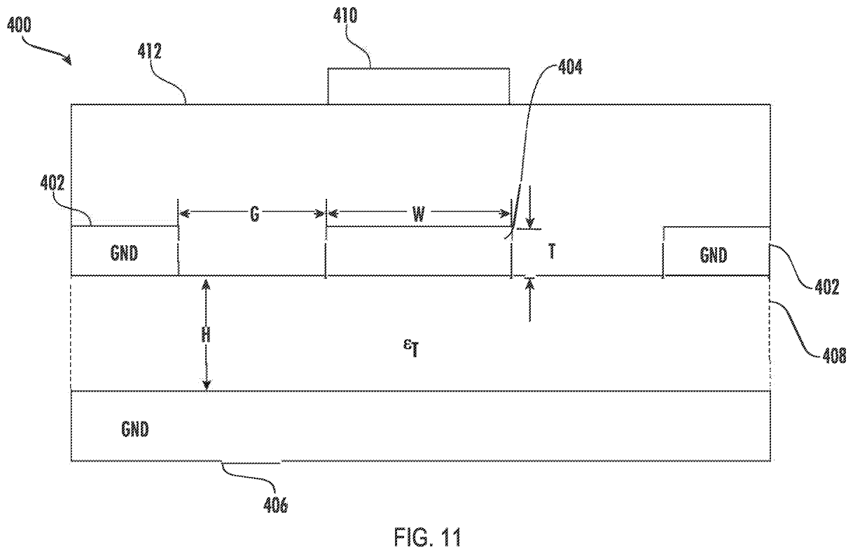

FIG. 11 illustrates a side elevation view of a co-planar waveguide antenna 400 configuration. One or more co-planar ground layers 402 can be arranged parallel with an antenna element 404 (e.g., a patch antenna element). Another ground layer 406 may be spaced apart from the antenna element by a substrate 408, which may be formed from the polymer composition of the present invention. One or more additional antenna elements 410 can be spaced apart from the antenna element 404 by a second layer or substrate 412, which may also be formed from the polymer composition of the present invention. The dimensions “G” and “W” may correspond with “feature sizes” of the antenna 400. The “G” dimension may correspond with a distance between the antenna element 404 and the co-planar ground layer(s) 406. The “W” dimension can correspond with a width (e.g., linewidth) of the antenna element 404. As such, in some embodiments, dimensions “G” and “W” may be relatively small (e.g., less than about 750 micrometers) such that the antenna 400 is a “fine pitch” antenna 400.

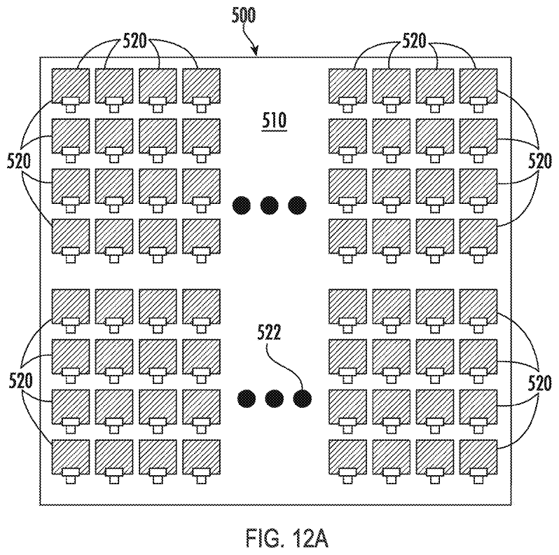

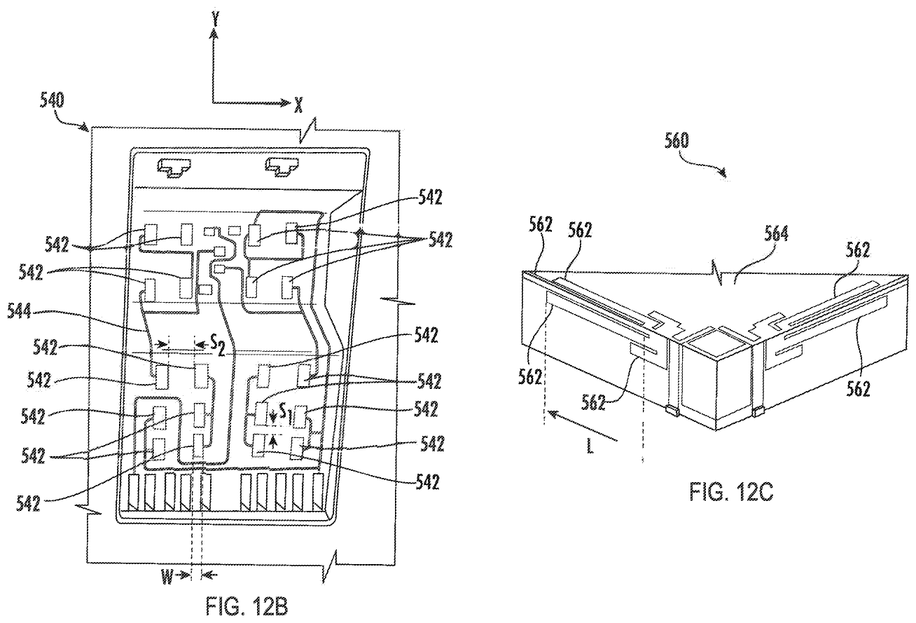

FIG. 12A illustrates an antenna array 500 according to another aspect of the present disclosure. The antenna array 500 can include a substrate 510, which may be formed from the polymer composition of the present invention, and a plurality of antenna elements 520 formed thereon. The plurality of antenna elements 520 can be approximately equally sized in the X- and/or Y-directions (e.g., square or rectangular). The plurality of antenna elements 520 can be spaced apart approximately equally in the X- and/or Y-directions. The dimensions of the antenna elements 520 and/or spacing therebetween can correspond with “feature sizes” of the antenna array 500. As such, in some embodiments, the dimensions and/or spacing may be relatively small (e.g., less than about 750 micrometers) such that the antenna array 500 is a “fine pitch” antenna array 500. As illustrated by the ellipses 522, the number of columns of antenna elements 520 illustrated in FIG. 12 is provided as an example only. Similarly, the number of rows of antenna element 520 is provided as an example only.

The tuned antenna array 500 can be used to provide massive MIMO functionality, for example in a base station (e.g., as described above with respect to FIG. 8). More specifically, radio frequency interactions between the various elements can be controlled or tuned to provide multiple transmitting and/or receiving channels. Transmitting power and/or receiving sensitivity can be directionally controlled to focus or direct radio frequency signals, for example as described with respect to the radio frequency signals 112 of FIG. 8. The tuned antenna array 500 can provide a large number of antenna elements 522 in a small footprint. For example, the tuned antenna 500 can have an average antenna element concentration of 1,000 antenna elements per square cm or greater. Such compact arrangement of antenna elements can provide a greater number of channels for MIMO functionality per unit area. For example, the number of channels can correspond with (e.g., be equal to or proportional with) the number of antenna elements.

FIG. 12B illustrates an antenna array 540 formed with laser direct structuring, which may optionally be employed to form the antenna elements. The antenna array 540 can include a plurality of antenna elements 542 and plurality of feed lines 544 connecting the antenna elements 542 (e.g., with other antenna elements 542, a front end module, or other suitable component). The antenna elements 542 can have respective widths “w” and spacing distances “S₁” and “S₂” therebetween (e.g., in the X-direction and Y-direction, respectively). These dimensions can be selected to achieve 5G radio frequency communication at a desired 5G frequency. More specifically, the dimensions can be selected to tune the antenna array 540 for transmission and/or reception of data using radio frequency signals that are within the 5G frequency spectrum. The dimensions can be selected based on the material properties of the substrate. For example, one or more of “w”, “S₁,” or “S₂” can correspond with a multiple of a propagation wavelength (“A”) of the desired frequency through the substrate material (e.g., nλ/4 where n is an integer).

As one example, λ can be calculated as follows:

$$λ = \frac{c}{f \sqrt{{ϵ}_{R}}}$$

where c is the speed of light in a vacuum, ∈_{R} is the dielectric constant of the substrate (or surrounding material), f is the desired frequency.

FIG. 12C illustrates an example antenna configuration 560 according to aspects of the present disclosure. The antenna configuration 560 can include multiple antenna elements 562 arranged in parallel long edges of a substrate 564, which may be formed from the polymer composition of the present invention. The various antenna elements 562 can have respective lengths, “L” (and spacing distances therebetween) that tune the antenna configuration 560 for reception and/or transmission at a desired frequency and/or frequency range. More specifically, such dimensions can be selected based on a propagation wavelength, λ, at the desired frequency for the substrate material, for example as described above with reference to FIG. 12B.

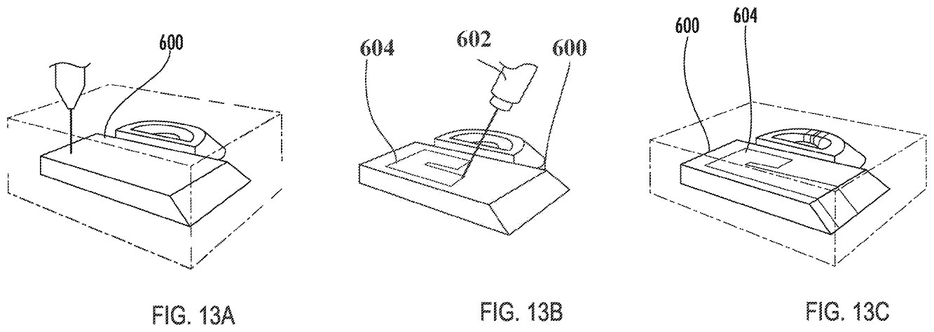

FIGS. 13A through 13C depict simplified sequential diagrams of a laser direct structuring manufacturing process that can be used to form antenna elements and/or arrays according to aspects of the present disclosure. Referring to FIG. 13A, a substrate 600 can be formed from the polymer composition of the present invention using any desired technique (e.g., injection molding). In certain embodiments, as shown in FIG. 13B, a laser 602 can be used to activate the laser activatable additive to form a circuit pattern 604 that can include one or more of the antenna elements and/or arrays. For example, the laser can melt conductive particles in the polymer composition to form the circuit pattern 604. Referring to FIG. 13C, the substrate 600 can be submerged in an electroless copper bath to plate the circuit pattern 604 and form the antenna elements, elements arrays, other components, and/or conductive lines therebetween.

The present invention may be better understood with reference to the following examples.

Test Methods

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×90 mm×3 mm or a disc sample having a 4-inch and 3-mm thickness may be inserted between two fixed dielectric resonators. The resonator measured the permittivity component in the plane of the specimen. Five (5) samples are tested and the average value is recorded. The split-post resonator can be used to make dielectric measurements in the low gigahertz region, such as 2 GHz or 10 GHz.

Heat Cycle Test: Specimens are placed in a temperature control chamber and heated/cooled within a temperature range of from −30° C. and 100° C. Initially, the samples are heated until reaching a temperature of 100° C., when they were immediately cooled. When the temperature reaches −30° C., the specimens are immediately heated again until reaching 100° C. Twenty three (23) heating/cooling cycles may be performed over a 3-hour time period.

Surface/Volume Resistivity: The surface and volume resistivity values are generally determined in accordance with IEC 62631-3-2-2016 and IEC 62631-3-1-1:2016, respectively, (equivalent to ASTM D257-14). According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density. In SI units, volume resistivity is numerically equal to the direct-current resistance between opposite faces of a one-meter cube of the material (ohm-m).

Electromagnetic Interference (“EMI”) Shielding: EMI shielding effectiveness may be determined in accordance with ASTM D4935-18 at frequency ranges ranging from 700 MHz to 18 GHz (e.g., 5 GHz). The thickness of the parts tested may vary, such as 1 millimeter, 1.6 millimeters, or 3 millimeters. The test may be performed using an EM-2108 standard test fixture, which is an enlarged section of coaxial transmission line and available from various manufacturers, such as Electro-Metrics. The measured data relates to the shielding effectiveness due to a plane wave (far field EM wave) from which near field values for magnetic and electric fields may be inferred.

Tensile Modulus, Tensile Stress, and Tensile Elongation at Break: Tensile properties may be tested according to ISO 527-1:2019 (technically equivalent to ASTM D638-14). Modulus and strength measurements may be made on a dogbone-shaped test strip sample having a length of 170/190 mm, thickness of 4 mm, and width of 10 mm. The testing temperature may be −30° C., 23° C., or 80° C. and the testing speeds may be 1 or 5 mm/min.

Flexural Modulus, Flexural Elongation at Break, and Flexural Stress: Flexural properties may be tested according to ISO 178:2019 (technically equivalent to ASTM D790-17). This test may be performed on a 64 mm support span. Tests may be run on the center portions of uncut ISO 3167 multi-purpose bars. The testing temperature may be −30° C., 23° C., or 80° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be −30° C., 23° C., or 80° C.

Deflection Temperature Under Load (“DTUL”): The deflection under load temperature may be determined in accordance with ISO 75-1,-2:2013 (technically equivalent to ASTM D648-07). More particularly, a test strip sample having a length of 80 mm, width of 10 mm, and thickness of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-2:2020. Under the DSC procedure, samples were heated and cooled at 20° C. per minute as stated in ISO Standard 10350 using DSC measurements conducted on a TA Q2000 Instrument.

Melt Viscosity: The melt viscosity (Pa-s) may be determined in accordance with ISO 11443:2021 at a shear rate of 1,000 s⁻¹ and temperature about 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

### Examples 1-4

Examples 1˜4 are formed from various combinations of a liquid crystalline polymer (LCP) and an aromatic polyhedral silsequioxane, i.e., trisilanolphenyl polyhedral octasilsesquioxane (“TSP-POSS) or dodecylphenyl polyhedral octasilsesquioxane (“DP-POSS”). LCP is formed from 79.3% HBA, 20% HNA, and 0.7% TA. Compounding was performed using an 32-mm single screw extruder. Parts are injection molded the samples into ISO tensile bars (Type 1) for mechanical property testing and discs (4-inch diameter, 0.8 mm thickness) for dielectric testing. The components of each Example are set forth in more detail below.

| | 1 | 2 | 3 | 4 |
|---|---|---|---|---|
| LCP | 100 | 95 | 98 | 95 |
| TSP-POSS | — | 5 | — | — |
| DP-POSS | — | — | 2 | 5 |

Examples 1-4 were tested for mechanical properties, thermal properties, and electrical properties as described herein. The results are set forth below.

| | 1 | 2 | 3 | 4 |
|---|---|---|---|---|
| Dielectric Constant at 10 HGz | 3.39 | 3.38 | 3.37 | 3.26 |
| Dissipation Factor at 10 GHz | 0.0017 | 0.0018 | 0.0018 | 0.0018 |
| Melting Point (° C.) | 323.9 | 325.2 | 330.5 | 330.9 |
| Melt Viscosity (Pa-s) at 1,000⁻¹ and 340° C. | 40.3 | 23.5 | 40.9 | 45.8 |
| DTUL (° C.) at 1.8 MPa | 198 | 198 | 194 | 199 |
| Charpy Notched (kJ/m²) | 95 | 106 | 75 | 82 |
| Tensile Strength (MPa) | 163 | 166 | 153 | 168 |
| Tensile Modulus (MPa) | 9,955 | 9,285 | 8,694 | 9,236 |
| Tensile Elongation (%) | 3.23 | 3.69 | 3.71 | 3.99 |
| Flexural Strength (MPa) | 163 | 160 | 150 | 159 |
| Flexural Modulus (MPa) | 10,088 | 9,838 | 9,110 | 9,720 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition that includes a polyhedral silsesquioxane (POSS) dispersed within a polymer matrix that contains a thermotropic liquid crystalline polymer, wherein the polyhedral silsesquioxane contains an aromatic group, wherein the polymer composition exhibits a dielectric constant of about 4.5 or less as determined at a frequency of 10 GHz.

2. The polymer composition of claim 1, wherein the thermotropic liquid crystalline polymer contains repeating units derived from one or more aromatic dicarboxylic acids, one or more aromatic hydroxycarboxylic acids, or a combination thereof.

3. The polymer composition of claim 2, wherein the aromatic hydroxycarboxylic acids include 4-hydroxybenzoic acid, 6-hydroxy-2-naphthoic acid, or a combination thereof.

4. The polymer composition of claim 2, wherein the aromatic dicarboxylic acids include terephthalic acid, isophthalic acid, 2,6-naphthalenedicarboxylic acid, or a combination thereof.

5. The polymer composition of claim 2, wherein the thermotropic liquid crystalline polymer further contains repeating units derived from one or more aromatic diols.

6. The polymer composition of claim 5, wherein the aromatic diols include hydroquinone, 4,4′-biphenol, or a combination thereof.

7. The polymer composition of claim 1, wherein the thermotropic liquid crystalline polymer is wholly aromatic.

8. The polymer composition of claim 1, wherein the polyhedral silsesquioxane constitutes from about 0.1 parts to about 20 parts by weight per 100 parts by weight of the polymer matrix.

9. The polymer composition of claim 1, wherein the polyhedral silsesquioxane is homoleptic.

10. The polymer composition of claim 9, wherein the polyhedral silsesquioxane contains optionally substituted phenyl groups.

11. The polymer composition of claim 10, wherein the polyhedral silsesquioxane includes octaphenyl-POSS, dodecaphenyl-POSS, polyphenyl-POSS, or a combination thereof.

12. The polymer composition of claim 1, wherein the polyhedral silsesquioxane is heteroleptic.

13. The polymer composition of claim 12, wherein the polyhedral silsesquioxane has the following general formula:
Rₙ₋ₘ[SiO_{1.5}]ₙYₘ
wherein,
R is an aromatic group;
n is 6, 8, 10, 12 or higher;
m is 1 to n; and
Y is an organic group containing a functional group.

14. The polymer composition of claim 13, wherein the aromatic group includes optionally substituted phenyl.

15. The polymer composition of claim 13, wherein n is 8, m is 1, 2, or 3, and Y is an aromatic group containing a functional group.

16. The polymer composition of claim 12, wherein the polyhedral silsesquioxane includes trisilanolphenyl-POSS.

17. The polymer composition of claim 1, wherein the polymer composition has a melting temperature of about 280° C. or more.

18. The polymer composition of claim 1, wherein liquid crystalline polymers constitute from about 50 wt. % to about 98 wt. % of the polymer composition.

19. The polymer composition of claim 1, further comprising a laser activatable additive.

20. The polymer composition of claim 19, wherein the laser activatable additive contains spinel crystals having the following general formula:
AB₂O₄
wherein,
A is a metal cation having a valance of 2; and
B is a metal cation having a valance of 3.

21. The polymer composition of claim 20, wherein the spinel crystals include MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, or a combination thereof.

22. The polymer composition of claim 1, further comprising a fibrous filler.

23. The polymer composition of claim 1, further comprising a particulate filler.

24. The polymer composition of claim 1, further comprising a hydrophobic material.

25. The polymer composition of claim 1, further comprising an electrically conductive material.

26. The polymer composition of claim 1, wherein the polymer composition exhibits a dissipation factor of about 0.05 or less at a frequency of 10 GHz.

27. The polymer composition of claim 1, wherein the composition exhibits a melt viscosity of about 100 Pa-s or less as determined at a shear rate of 1,000 seconds⁻¹ and at a temperature of about 15° C. greater than a melting temperature of the composition.

28. A molded part that comprises the polymer composition of claim 1.

29. The molded part of claim 28, wherein one or more conductive elements are formed on a surface of the part.

30. An antenna system that comprises a substrate that includes the polymer composition of claim 1 and at least one antenna element configured to transmit and receive radio frequency signals, wherein the antenna element is coupled to the substrate.

31. The antenna system of claim 30, wherein the radio frequency signals are 5G signals.

32. The antenna system of claim 30, wherein the at least one antenna element has a feature size that is less than about 1,500 micrometers.

33. The antenna system of claim 30, wherein the at least one antenna element comprises a plurality of antenna elements.

34. The antenna system of claim 33, wherein the plurality of antenna elements are spaced apart by a spacing distance that is less than about 1,500 micrometers.

35. The antenna system of claim 33, wherein the plurality of antenna elements comprise at least 16 antenna elements.

36. The antenna system of claim 33, wherein the plurality of antenna elements are arranged in an array.

37. The antenna system of claim 36, wherein the array is configured for at least 8 transmission channels and at least 8 reception channels.

38. The antenna system of claim 36, wherein the array has an average antenna element concentration of greater than 1,000 antenna elements per square centimeter.

39. The antenna system of claim 30, further comprising a base station, and wherein the base station comprises the at least one antenna element.

40. The antenna system of claim 30, further comprising at least one of a user computing device or a repeater, and wherein the at least one of the user computing device or the repeater base station comprises the at least one antenna element.
